(19) United States
(12) Patent Application Publication
(10) Pub. No.: US 2020/0082001 A1
(43) Pub. Date: Mar. 12, 2020

(54) Action-Based Image Searching and Identification System

(71) Applicant: Salesforce.com, inc., San Francisco, CA (US)

(72) Inventors: Yujing Chen, Dale City, CA (US); Billy Ma, Berkeley, CA (US)

(21) Appl. No.: 16/124,761

(22) Filed: Sep. 7, 2018

(51) Int. Cl. G06F 17/30; G06T 7/10

(52) U.S. Cl. CPC G06F 17/30247; G06T 2207/20132; G06T 7/10; G06F 17/30991

(57) ABSTRACT

Disclosed herein are system, method, and computer program product embodiments for providing an action-based image searching and identification system. An embodiment operates by receiving an image and a query associated with the image. From the image an object associated with the query is identified. A feature of the identified object and associated with the query is determined. One of a plurality of possible actions is selected based on the feature. A result of the query including the selected action is returned.

### BACKGROUND

Conventional search systems that receive images from a user, often return other similar images as search results. However these search systems do not allow the user to also submit a text-based query about an object appearing in the image. For example, a search system receiving an image of a car may return other similar images of cars. However, the search system does not allow the user to submit a query about the dimensions of the car with the image. Instead the user must identify the car during a first search, and then submit a second search requesting dimensions of the identified car. Performing these multiple-query based searches requires transmitting multiple queries, executing multiple queries, and returning the multiple query results all of which consume additional bandwidth and processing resources.

### BRIEF DESCRIPTION OF THE DRAWINGS

The accompanying drawings are incorporated herein and form a part of the specification.

FIG. 1 is a block diagram illustrating example functionality for providing an action-based image searching and identification system, according to some embodiments.

FIG. 2 is a flowchart illustrating example operations of an action-based image searching and identification system, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an action-based image searching and identification system.

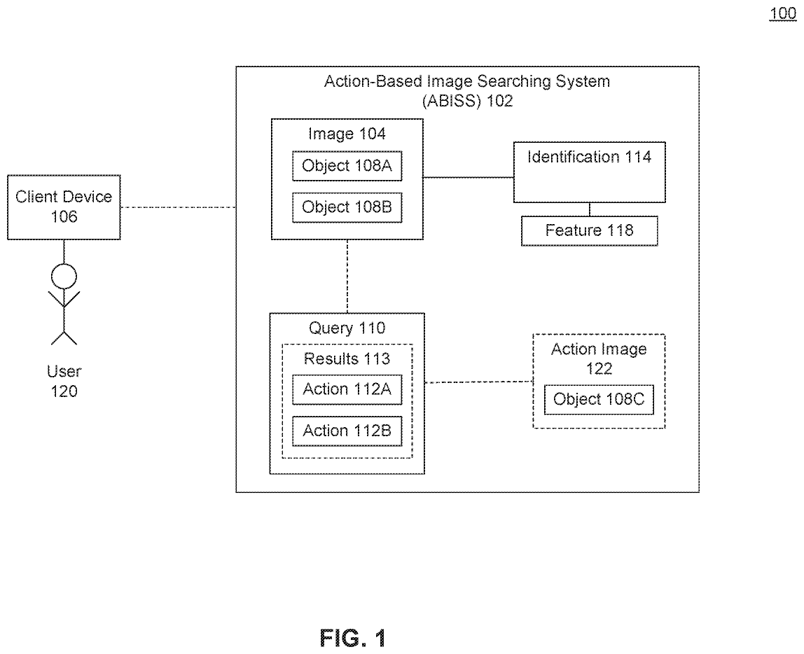

FIG. 1 is a block diagram 100 illustrating example functionality for providing an action-based image searching and identification system, according to some embodiments. An action-based image searching system (ABISS) 102 may perform combination image and text based query searches on input data. For example, ABISS 102 may receive input data including an image 104 and a query 110 about an object 108 in the image 104. ABISS 102 may identify the object 108 in the image 104, and provide query results 113 based in part on an identification of the object 108.

For example, if a user wants to query the features of a car in a picture, the user would have to submit a first query trying to identify the car in the picture. A search system would process the first query and return the results. After receiving and parsing through the results, and positively identifying the car. The user would then have to submit a second query asking about the features of the user-identified car. The search system would then process the second query and again return query results. This multiple back-and-forth query and result interaction requires additional time, transmission bandwidth, and overhead.

ABISS 102 may reduce the transmission overhead and bandwidth that may otherwise be required in multiple query based searches by performing combination image and query based searches. For example, ABISS 102 may enable the user to submit both an image 104 and query 110 (about one or more objects 108 in the image 104) in a single transmission (with shared transmission overhead), and without specifically identifying the object 108 in the image 104. ABISS 102 may then identify the object 108, process the query 110 based on the object identification 114, and return a single set of results 113 (with shared transmission overhead).

Image 104 may be a visual representation of one or more items or objects 108. Image 104 may be a digital picture taken with a client device 106, such as a mobile phone, tablet computing device, or laptop. In other embodiments image 104 may be a video, a scanned image, a digitally rendered image, picture, augmented reality (AR) or virtual reality (VR) image, or any other visual representation.

Object 108 may be any item or subject matter within image 104 which is to be identified or about which a query 110 is directed. A particular image 104 may include multiple items, only a subset of which may be objects 108 about which a query 110 is targeted. For example, image 104 may include three different types of toys: a car, a fire truck, and an action figure. However, the query 110 may only be associated with the action figure object 108, requesting a price of the selected toy.

ABISS 102 may determine how many distinct objects 108 are to be identified within image 104. In an embodiment, using whitespace identification, or background color identification, ABISS 102 may differentiate between various items or objects 108 within image 104. For example, image 104 may include a picture of leftover items on a lunch tray, such as an orange peel, an empty aluminum can, and a paper sandwich wrapper.

By contrasting foreground objects and colors with background colors (e.g., a known or identified color of the lunch tray), ABISS 102 may be able to distinguish the items on the lunch tray from the lunch tray itself, ABISS 102 may identify whatever objects 108 that do not correspond to the lunch tray color.

In an embodiment, ABISS 102 may crop the various objects 108 from image 104 and perform an image search to identify or classify each of the various cropped objects 108 relevant to answering or responding to the query 110. In another embodiment, the objects 108 may not be cropped from image 104. A classification may be a general category in which the object belongs, for example, a classification of an object 108A may be car, while an identification 114 of the object 108A may include the make, model, year, and/or color of the car. As used herein, identification and classification may be referred to interchangeably as identification 114.

The user 120 may use a client device 106 to submit a query 110 with image 104. Client device 106 may include a web-based program, e-mail message, text message, or an app on client device 106 that is communicatively coupled to ABISS 102. Query 110 may include a text-based question about one or more objects 108 from one or more images 104. For example, a 120 user may type or speak a query 110 asking about an object 108 from image 104.

In order to respond to query 110, ABISS 102 may first identify an object 108 from image 104, and then determine one or more features 118 of the object 108, based on the identification 114. Features 118 may include any information about an object 108 that is not determined based on image 104. Features 118 may include facts, classifications, categorizations, dimensions, or other aspects of the identified objects 108A that are associated with query 110 (based at least in part on identification 114).

In continuing the example above, example aluminum can features may include 1) whether aluminum cans are recyclable, and 2) in which bin aluminum can is to be disposed of for recycling purposes. In an embodiment, ABISS 102 may retrieve this information from an Internet or database search. Based on the features 118, ABISS 102 may generate result 113 indicating an action 112 indicating that the aluminum can is recyclable and belongs in recycling bin 2. Example features of a car may include the fuel economy, the price, where it can be purchased, resale value, warranty information, dimensions, etc.

In an embodiment, query 110 may include a recommendation about what action 112 to take with regard to one or more objects 108. Action 112 may be a real-world or physical action to be taken by a user 120, responsive to query 110.

For example, user 120 may use a camera on client device 106 to take a picture 104 of the leftover items on the user's lunch tray. Using the associated program on client device 106, user 120 may submit, with image 104, a query 110 requesting guidance as to which actions 112 to take to properly dispose of the items on the lunch tray (e.g., into which trash or recycling bins to dispose of the items). ABISS 102 may identify the objects 108 from the lunch tray, and return a set of results 113 may suggest actions 112A, 112B indicating into which trash bin or recycling bin each identified object 108 belongs (e.g., actions 112A, 112B).

In an embodiment, ABISS 102 may be preconfigured to answer particular action-based queries 110. In continuing the lunch tray example, ABISS 102 may be pre-configured to answer garbage disposal and recycling questions. ABISS 102 may have access to one or more databases of information regarding identifying items for recycling and trash disposal purposes.

In an embodiment, ABISS 102 may compare visual features of the object 108 against a cataloged number of previously identified objects in the databases, and return an identification of the selected object 108. For example, in continuing the lunch tray example, an image search of the selected item may return an intermediate result identifying a selected object 108A as an aluminum can.

In an embodiment, a particular query 110 may need to be submitted by user 120, but instead may already be known by ABISS 102. For example, an app on client device 106 may enable a user to take and submit an image 104 of items to be disposed of, and receive results 113 indicating how to dispose of the items (actions 112). Upon receiving image 104, ABISS 102 may already be pre-configured to respond to the disposal query 110. ABISS 102 may then return the result 113 through the app or web-based program on client device 106.

In an embodiment, ABISS 102 may generate a composite query from image 104 and query 110. The composite query may include a first query in which the objects 108A, 108B are identified 114, and a second query in which a response to the submitted (text-based) query 110 and the object identification 114 is generated.

In continuing the lunch tray example above, the first (image-based) query may be to identify the selected objects 108A from the picture of the user's lunch tray. The intermediate result of the first query may be an identification 114 of an aluminum can object 108. The second or composite query may be into which bin user 120 should dispose of an aluminum can.

In an embodiment, ABISS 102 may use multiple images 104 to identify an object 108. For example, image 104 may include multiple images taken of a particular object 108 from various angles or other photographic adaptations, such as distance, brightness, time of day, etc. For example, an image 104 of a car 108 may include an image of the front of the car, an image of the side of the car, and an image of the back of the car. Or, for example, an image 104 of a car may include two images of the same car in different colors.

In an embodiment, user 120 may indicate the various objects 108 of image 104 that relate to query 110. For example, on a touchscreen device 106, user 120 may use their finger to select or draw a border around the one or more objects 108 on a digital rendering of image 104 associated with query 110. For example, if image 104 includes a picture of a person standing next to a car. ABISS 102 may receive an indication (e.g., finger touch or outline) of the car in image 104, and a query 110 that user 120 is requesting information on where to purchase the car or get the car serviced.

In an embodiment, ABISS 102 may receive an action image 122. Action image 122 may include a number of different objects 108 related to possible actions 112 of query 110. In continuing the lunch tray example, action image 122 may include a digital image of the various disposal options (e.g., such as a trash can, and two possible recycling bins).

ABISS 102 may analyze the color and markings on each bin and determine which bins are used for which objects 108. ABISS 102 may retrieve features 118 of the bins 108C in the action image 122, compare them to the features 118 of the food items 108A, 108B, and determine actions 112 of how to dispose of the food items 108A, 108B. In an embodiment, ABISS 102 may return the cropped object 108 and/or identification 114 as part of the result 113.

Rather than simply processing queries or performing image searches, ABISS 102 combines the features of multiple search systems into one, saving bandwidth, time, and processing resources that would otherwise be necessary for a user 120 to submit multiple queries to different systems and trying to manually accumulate the results.

For example, rather than requiring a user to take an image of each item on a lunch tray, perform an individualized search to identify the items, and them submit separate queries about how to dispose of each item, ABISS 102 is configured to perform all of these actions with a submission of a single image 104, which consumes fewer resources (such as memory on client device 106) and less bandwidth in the back-and-forth transmission of multiple queries and results.

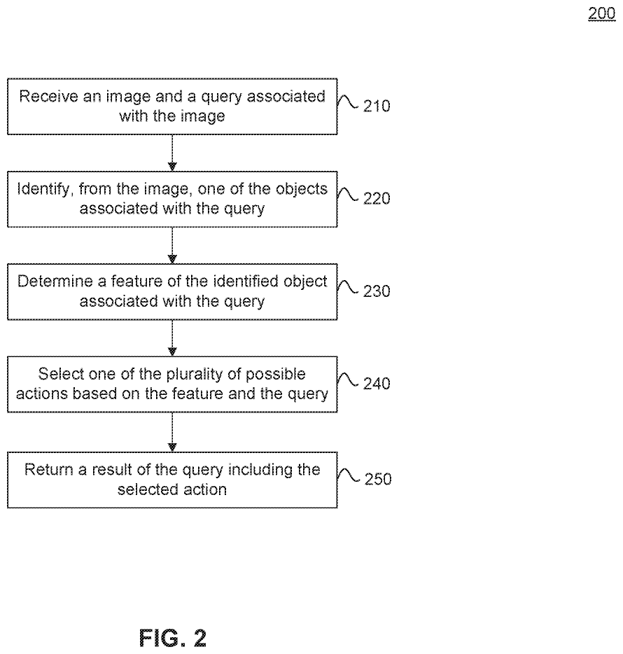

FIG. 2 is a flowchart 200 illustrating example operations of an action-based image searching and identification system, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1. However, method 200 is not limited to the example embodiments.

In 210, an image and a query associated with the image are received. For example, ABISS 102 may receive image 104 and query 110 from client device 106. In an embodiment, user 120 may indicate which object(s) 108 of image 104 are related to the query 110. Query 110 may include a list of one of more possible actions 112 the user 120 may take with regard to object 108, and request information regarding an action 112 or recommendation as to which of one or more possible actions 112 the user 120 should take regarding the indicated or selected object(s) 108.

For example, query 110 may ask which printer cartridge out of multiple printer cartridge objects 108 in image 104 a user 120 should purchase for a specified printer. In an embodiment, the specified printer may be an object 108C that is submitted in an action image 122 (picture of the printer).

In 220, one of objects associated with the query is identified from the image. In continuing the printer example, ABISS 102 may identify the printer in action image 122. ABISS 102 may also identify which print cartridges 108 are displayed in image 104.

In an embodiment, ABISS 102 may return two possible printers that correspond to the printer of action image 122 to the user 120. For example, a specific printer may include 2 different models that look similar or identical. The user 120 may then select or confirm which printer is actually featured in the image 122, or which description or terminology more accurately describes the printer object 108C. In an embodiment, ABISS 102 may request additional information from user 120, such as a model year or manufacturer name in order to make identification 114.

In 230, a feature of the identified object associated with the query is determined. For example, ABISS 102 may determine the type of print cartridges that the identified printer uses.

In 240, one of the plurality of possible actions is selected based on the feature and the query. For example, ABISS 102 may determine which or whether any of the printer cartridges in the image 122 is compatible with the identified printer. If there is a positive match, ABISS 102 may select the action of purchasing the compatible cartridge. Or, for example, ABISS 102 may select no purchase if none of the cartridges are compatible with the printer.

In an embodiment, a first set of printer cartridges from image 104 may be compatible with the printer, and a second set of printer cartridges from image 104 may not be compatible with the printer. ABISS 102 may then recommend purchasing one or more cartridges from the first set.

In 250, return a result of the query including the selected action. For example, ABISS 102 may return result 113 including an identification of the printer from action image 122, an identification of the cartridges from image 104, and the suggested action. In an embodiment results 113 may include a list of stores where the cartridge can be purchased and the prices.

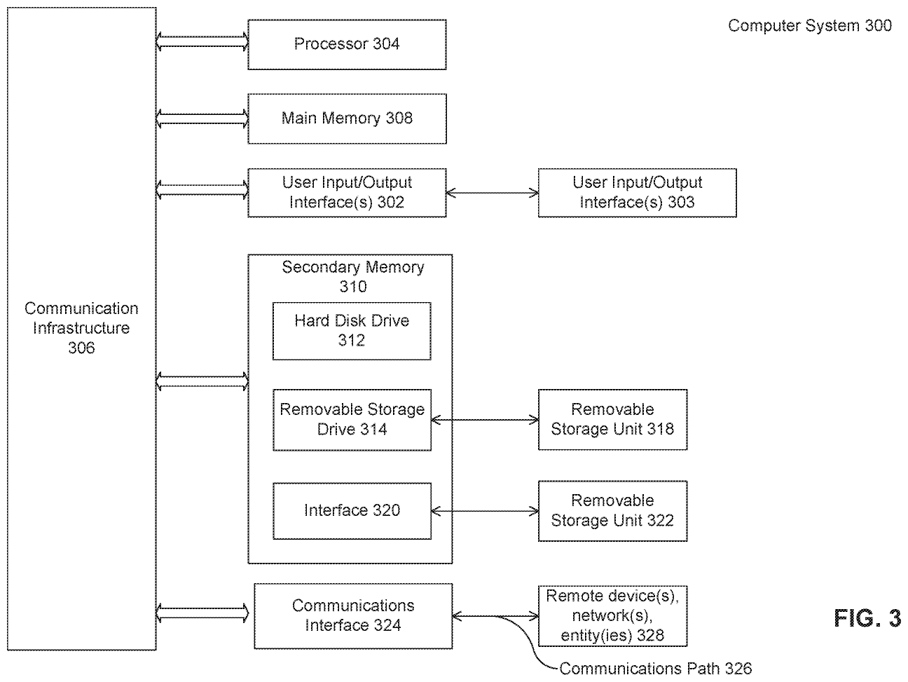

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include customer input/output device(s) 303, such as monitors, keyboards, pointing devices, etc., which may communicate with communication infrastructure 306 through customer input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot; and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly, described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving an image and a query associated with the image, wherein the query comprises a plurality of possible actions regarding one or more objects of the image;
identifying, from the image, one of the objects associated with the query;
determining, by at least one processor, a feature of the identified object associated with the query;
selecting one of the plurality of possible actions based on the determined feature; and
returning, responsive to the query associated with the image; a result of the query including the selected action.

2. The method of claim 1, wherein the identifying comprises:
identifying a plurality of objects in the image;
selecting one of the objects in the image associated with the query; and
identifying the selected object.

3. The method of claim 2, wherein the selecting comprises:
cropping the selected object from the image.

4. The method of claim 3; wherein the returning comprises:
returning the cropped object with the result of the query.

5. The method of claim 1, wherein the identifying comprises:
providing one or more terms associated with the object in the image to a user device; and
receiving, from the user device; an indication as to which of the one or more terms correspond to the object.

6. The method of claim 1, wherein the determining comprises:
determining a first category of objects corresponding to a first one of the plurality of actions;
determining a second category of objects corresponding to a second one of the plurality of actions; and
determining that the object belongs to the first category, wherein the result comprises the first action and an indication of the first category.

7. The method of claim 1, wherein the receiving comprises:
receiving a second image associated with the first image;
identifying one or more objects of the second image, wherein each object from the second image is associated with one of the plurality of actions; and
determining the plurality of actions based on the identified one or more objects of the second image.

8. A system comprising:
a memory; and
at least one processor coupled to the memory and configured to:
receive an image and a query associated with the image, wherein the query comprises a plurality of possible actions regarding one or more objects of the image;
identify, from the image, one of objects associated with the query;
determine, by the at least one processor, a feature of the identified object associated with the query;
select one of the plurality of possible actions based on the determined feature; and
return; responsive to the query associated with the image, a result of the query including the selected action.

9. The system of claim 8, wherein the at least one processor that identifies is configured to:
identify a plurality of objects in the image;
select one of the objects in the image associated with the query; and
identify the selected object.

10. The system of claim 9, wherein the at least one processor that selects is configured to:
crop the selecting object from the image.

11. The system of claim 10, wherein the at least one processor that returns is configured to:
return the cropped object with the result of the query.

12. The system of claim 8, wherein the at least one processor that identifies is configured to:
provide one or more terms identifying the object in the image to a user device; and
receive, from the user device, an indication as to which of the one or more terms correspond the object.

13. The system of claim 8, wherein the at least processor that determines is configured to:
determine a first category of objects corresponding to a first one of the plurality of actions;
determine a second category of objects corresponding to a second one of the plurality of actions; and
determine that the object belongs to the first category, wherein the result comprises the first action and an indication of the first category.

14. The system of claim 8, wherein the at least one processor that receives is configured to:
receive a second image associated with the first image;
identify one or more objects of the second image, wherein each object is associated with one of the plurality of actions; and
determine the plurality of actions based on the identified one or more objects of the second image.

15. A non-transitory computer-readable device having instructions stored thereon that, when executed by at least one computing device, cause the at least one computing device to perform operations comprising:
receiving an image and a query associated with the image, wherein the query comprises a plurality of possible actions regarding one or more objects of the image;
identifying, from the image, one of objects associated with the query;
determining, by at least one processor, a feature of the identified object associated with the query;
selecting one of the plurality of possible actions based on the determined feature; and
returning, responsive to the query associated with the image, a result of the query including the selected action.

16. The non-transitory computer-readable device of claim 15, wherein the identifying comprises:
identifying a plurality of objects in the image;
selecting one of the objects in the image associated with the query; and
identifying the selected object.

17. The non-transitory computer-readable device of claim 16, wherein the selecting comprises:
cropping the selecting object from the image.

18. The non-transitory computer-readable device of claim 17, wherein the returning comprises:
returning the cropped object with the result of the query.

19. The non-transitory computer-readable device of claim 15, wherein the identifying comprises:
providing one or more terms identifying the object in the image to a user device; and
receiving, from the user device, an indication as to which of the one or more terms correspond the object.

20. The non-transitory computer-readable device of claim 15, wherein the determining comprises:
determining a first category of objects corresponding to a first one of the plurality of actions;
determining a second category of objects corresponding to a second one of the plurality of actions; and
determining that the object belongs to the first category, wherein the result comprises the first action and an indication of the first category.
